(19) United States
(12) Patent Application Publication
(10) Pub. No.: US 2024/0098429 A1
(43) Pub. Date: Mar. 21, 2024

(54) Hearing Aid Device with Intonation Boosting

(71) Applicants: Board of Regents, The University of Texas System, Austin, TX (US); University of Rochester, Rochester, NY (US)

(72) Inventors: Eric A. Freudenthal, El Paso, TX (US); Chigusa Kurumada, Rochester, NY (US)

(21) Appl. No.: 18/466,440

(22) Filed: Sep. 13, 2023

Related U.S. Application Data
(60) Provisional application No. 63/375,914, filed on Sep. 16, 2022.

(51) Int. Cl. H04R 25/00; G10L 21/028; G10L 21/0364

(52) U.S. Cl. CPC H04R 25/43; G10L 21/028; G10L 21/0364; H04R 2225/43

(57) ABSTRACT

A method for assisting recognition of intonation of speech is provided. The method comprises detecting voice an utterance by a hearing aid and generating a raw voice signal produced by the voice utterance. The hearing aid processes the raw voice signal to generate an intelligibility signal that boosts and equalizes frequencies related to intelligibility of phonemes of the voice utterance. The hearing aid processes the raw voice signal to generate an intonation signal that isolates the fundamental frequency related to intonation of the voice utterances. The hearing aid mixes the intelligibility signal and the intonation signal to generate and output an intelligible speech signal with a boosted fundamental frequency.

### CROSS-REFERENCE TO RELATED APPLICATION

This application claims the benefit of U.S. Provisional Patent Application Ser. No. 63/375,914, filed Sep. 16, 2022, and entitled “Hearing Aid Device with Intonation Boosting,” which is incorporated herein by reference in its entirety.

### BACKGROUND INFORMATION

### 1. Field

The present disclosure relates to hearing aids, and more specifically to a device that increases the ability of the wearer to discern intonation.

### 2. Background

Verbal language includes segmental and suprasegmental information. Segmental information comprises what is said (e.g., consonants, vowels, words, etc.). Suprasegmental information comprises how something is said (e.g., rhythm, tempo, and intonation).

Presbycusis (age-related hearing loss) is thought to primarily reduce sensitivity and acuity of higher frequency formants critical to recognizing phonemes. The resulting impairment of functional language recognition has motivated hearing aid designers to focus on the reinforcement of formants.

Therefore, it would be desirable to have a method and apparatus that take into account at least some of the issues discussed above, as well as other possible issues.

### SUMMARY

An illustrative embodiment provides a method for assisting recognition of intonation of speech. The method comprises detecting a voice utterance by a hearing aid and generating a raw voice signal produced by the voice utterance. The hearing aid processes the raw voice signal to generate an intelligibility signal that boosts and equalizes frequencies related to intelligibility of phonemes of the voice utterance. The hearing aid processes the raw voice signal to generate an intonation signal that isolates the fundamental frequency related to intonation of the voice utterance. The hearing aid mixes the intelligibility signal and the intonation signal to generate an intelligible speech signal with a boosted fundamental frequency and outputs the intelligible speech signal with the boosted fundamental frequency.

Another illustrative embodiment provides a hearing aid system for assisting recognition of intonation of speech. The hearing aid system comprises a storage device configured to store program instructions and one or more processors operably connected to the storage device and configured to execute the program instructions to cause the hearing aid system to: detect a voice utterance; generate a raw voice signal produced by the voice utterance; process the raw voice signal to generate an intelligibility signal that boosts and equalizes frequencies related to intelligibility of phonemes of the voice utterances; process the raw voice signal to generate an intonation signal that isolates the fundamental frequency related to intonation of the voice utterance; mix the intelligibility signal and the intonation signal to generate an intelligible speech signal with a boosted fundamental frequency; and output the intelligible speech signal with the boosted fundamental frequency.

Another illustrative embodiment provides a hearing aid device. The hearing aid device comprises: an input transducer that generates a raw voice signal in response to detecting a voice utterance; an intelligibility processor that processes the raw voice signal to generate an intelligibility signal that boosts and equalizes frequencies related to intelligibility of phonemes of the voice utterance; an intonation processor that processes the raw voice signal to generate an intonation signal that isolates the fundamental frequency related to intonation of the voice utterance; a mixer that mixes the intelligibility signal and the intonation signal to generate an intelligible speech signal with a boosted fundamental frequency; and an output transducer that emits the intelligible speech signal with the boosted fundamental frequency.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 depicts a block diagram illustrating a hearing aid device with intonation boosting in accordance with an illustrative embodiment;

FIG. 2 depicts a block diagram illustrating an intonation processor in accordance with an illustrative embodiment;

FIG. 3 depicts a frequency analysis graph of a raw voice signal;

FIG. 4 depicts a frequency analysis graph of a high-intelligibility voice signal in accordance with an illustrative embodiment;

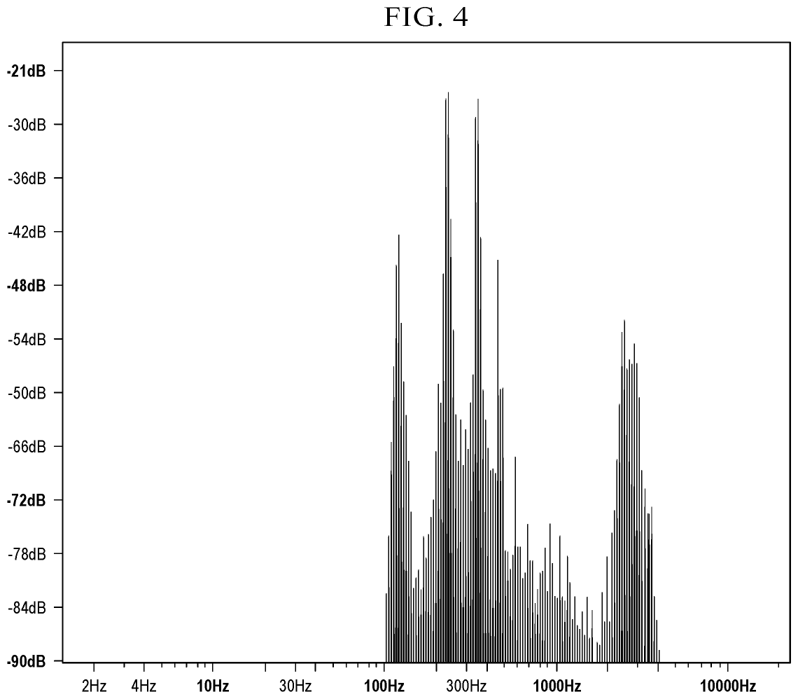

FIG. 5 depicts a frequency analysis graph of an isolated f₀ signal in accordance with an illustrative embodiment;

FIG. 6 depicts a frequency analysis graph of a high-intelligibility h-boosted voice signal in accordance with an illustrative embodiment;

FIG. 7 depicts a flow chart illustrating a process for assisting recognition of intonation of speech in accordance with an illustrative embodiment;

FIG. 8 depicts a block diagram illustrating a schematic diagram of hearing aid device incorporated into a mobile device in accordance with an illustrative embodiment;

FIG. 9 illustrates a computer software system for directing the operation of the data-processing system, in accordance with an example embodiment; and

FIG. 10 illustrates a schematic view of a software system including a module, an operating system, and a user interface, in accordance with an example embodiment.

### DETAILED DESCRIPTION

The illustrative embodiments recognize and take into account one or more considerations. For example, the illustrative embodiments recognize and take into account that verbal language includes segmental, which comprises what is said, and suprasegmental information, which comprises how something is said. For example, in the English language, segmental information primarily takes the form of phonemes that distinguish lexical meaning of words (e.g., pet vs. pat).

The illustrative embodiments also recognize and take into account that phonemes are principally comprised of resonances in vocal cavities with the speaker's head called formants. The energy of the vowels primarily lies in the range of 250-2,000 Hz. The energy of voiced consonants (e.g., b, d, m, etc.) is in the range of 25-4,000 Hz. Unvoiced consonants (e.g., f, s, t, etc.) vary considerably in strength and line in the frequency range 2,000-8,000 Hz.

The illustrative embodiments also recognize and take into account that presbycusis (age-related hearing loss) is thought to primarily reduce sensitivity and acuity of higher frequency formants critical to recognizing phonemes. The resulting impairment of functional language recognition has motivated hearing aid designers to focus on the reinforcement of formants to the extent that intonation frequency is suppressed. However, an undesirable side-effect of the suppressed intonation in current hearing aids is pragmatic speech problems similar to Autism Spectrum Disorder (ASD).

The illustrative embodiments provide a hearing aid that boosts intonation frequency (fundamental frequency f₀) and other frequencies in its harmonic series that enhance awareness of intonation and minimize interference with phoneme intelligibility. This effective is achieved by selective inclusion of those frequencies as received by the hearing aid's microphone(s) and/or by synthesis of signals that convey key aspects of the speaker's intonation to the hearing aid's wearer.

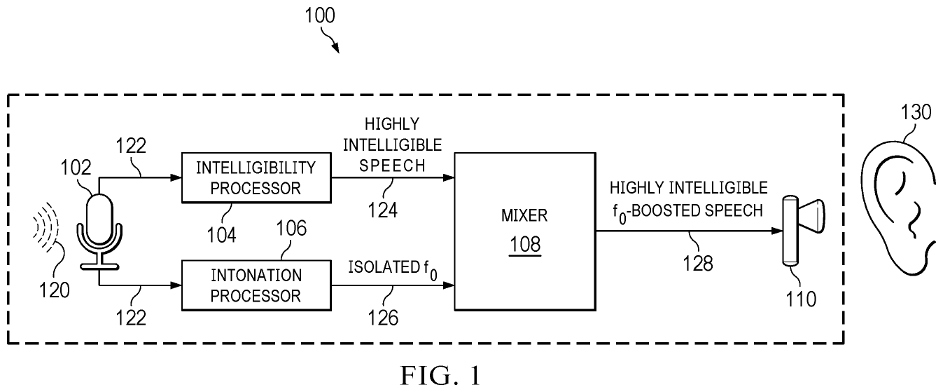

FIG. 1 depicts a block diagram illustrating a hearing aid device with intonation boosting in accordance with an illustrative embodiment. Hearing aid device 100 comprises an input transducer 102 (i.e., microphone) that generates signals 122 in response to detecting sound 120, including voice utterances.

In accordance with the example illustrated, the input transducer 102 may couple to an intelligibility processor 104 and an intonation processor 106 through either wired or wireless connections. The wireless connection can be, for example, a packet-based wireless communications protocol.

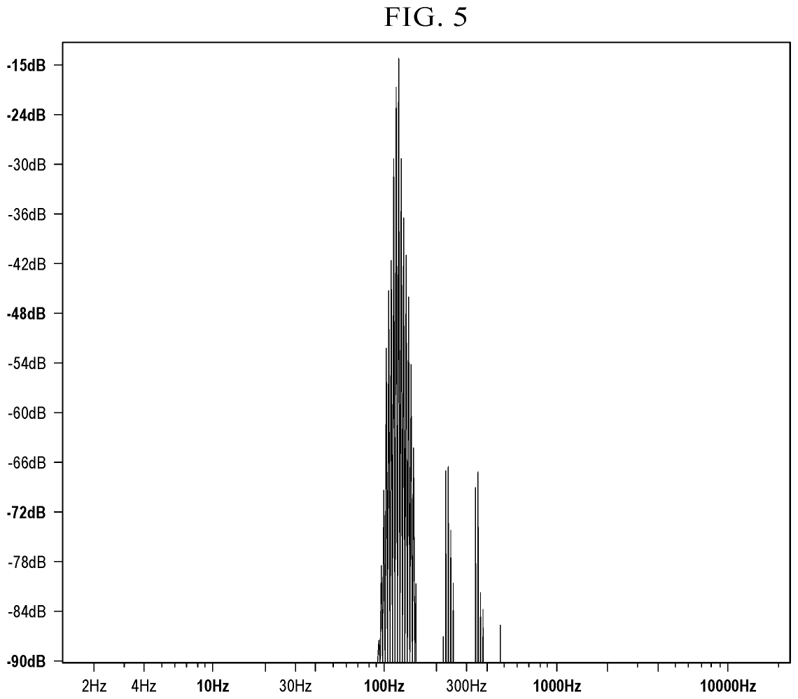

The intelligibility processor 104 modifies the signal 122 generated by the input transducer 102 to optimize intelligibility by the wear aid's wearer. This modification may include frequency equalization (varied gain over frequency) and amplitude compression. Sound components that do not contribute to intelligibility are generally suppressed. It is widely known that the signals required for intelligibility are in the range of approximately 300 Hz to 4 kHz. The intelligibility processor 104 produces an intelligibility signal 124 representing highly intelligible speech. FIG. 5 depicts a frequency analysis graph of a high-intelligibility voice signal.

The intonation processor 106 modifies the signal generated by the input transducer 102 to produce an isolated f₀ signal 126 at the intonation frequency (f₀) of voiced phonemes received by the input transducer 102. FIG. 5 depicts a frequency analysis graph of an isolated f₀ signal. Isolated f₀ signal 126 comprises amplitudes corresponding to the loudness of the phoneme's intonation, which is often suppressed by conventional hearing aids. Since much supra-segmental information is conveyed through intonation, the isolated f₀ signal 126 directly represents and conveys that information.

Though an utterance has only one intonation frequency at any particular moment, the f₀ of a prolonged utterance may shift over time. Intonation processor 106 tracks f₀ in real-time and is therefore able to capture any shifts in f₀ from moment to moment, thereby preserving intonation information.

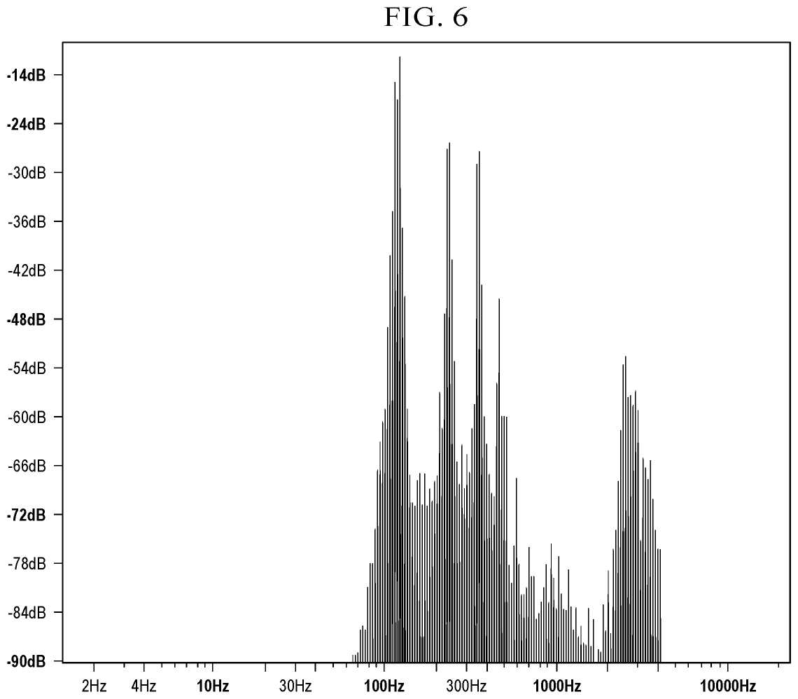

Mixer 108 sums intelligibility signal 124 and intonation signal 126 to produce a highly-intelligible f₀-boosted speech signal 128 that feeds into an acoustic output transducer 110 coupled to the wearer's ear 130. FIG. 6 depicts a frequency analysis graph of a high-intelligibility f₀-boosted voice signal.

Again, intelligibility processor 104 and an intonation processor 106 may couple to the mixer 108 through either wired or wireless connections. In an embodiment, amplitude measurements among the components are transmitted such that signal levels emitted by the intonation processor 106 and intelligibility processor 104 are appropriately mixed to facilitate the wearer's perception of segmental and supra-segmental information.

The functionality of intelligibility processor 104, intonation processor 106, and mixer 108 may be incorporated into separate hardware components or into a single integrated hardware system.

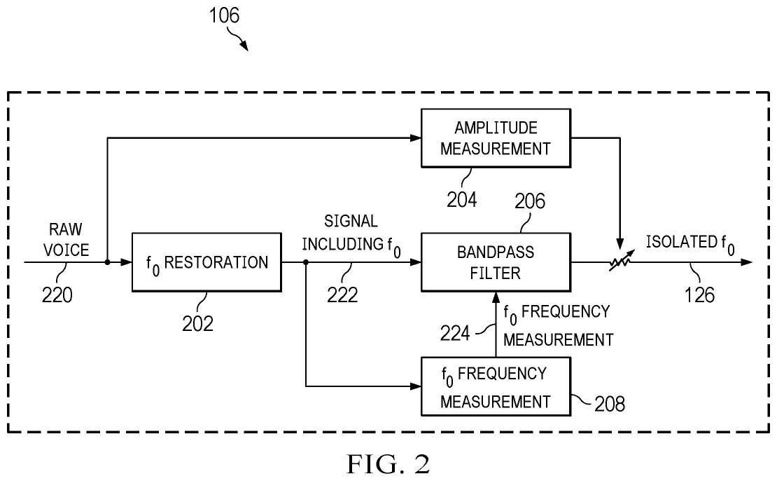

FIG. 2 depicts a block diagram illustrating an intonation processor in accordance with an illustrative embodiment. FIG. 2 depicts an example implementation of intonation processor 106 in FIG. 1.

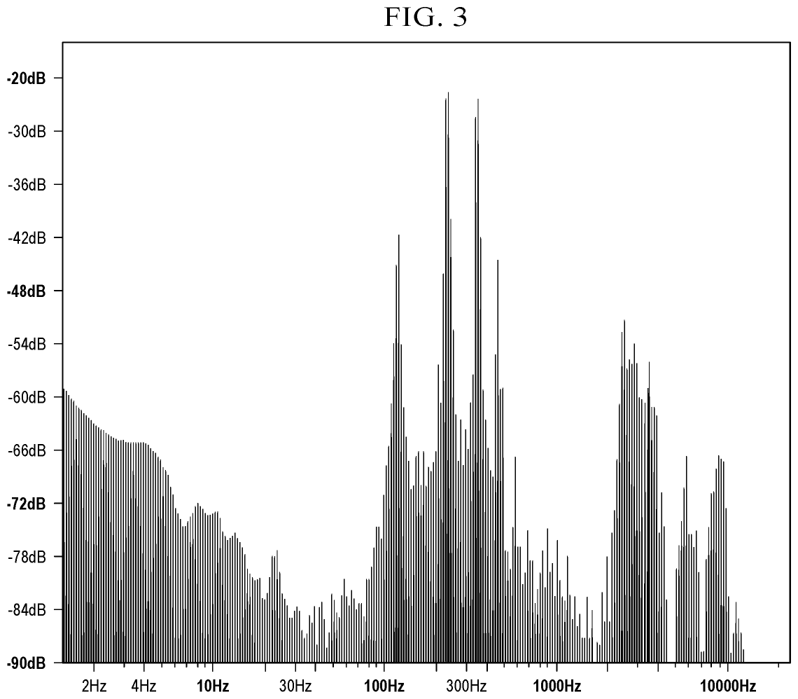

FIG. 3 depicts a frequency analysis graph of a raw voice signal. The role of the intonation processor 106 is to generate an isolated f₀ signal 126 at the same frequency as the intonation signal within voiced phonemes of the raw voice signal 220. In the illustrative embodiment, f₀ restoration circuit 202 utilizes heterodyne mixing to ensure that signals at the intonation frequency f⁰ are at high relative amplitude to its harmonics within vocal formants.

The f₀ restoration 222 signal which includes f₀ is transmitted to an f₀ frequency measurement circuit 208 that determines a scalar value of intonation h. The resulting f₀ frequency measurement signal 224 is used to center the passband of a bandpass filter 206 that isolates f₀ from the f₀ restoration signal 222 produced by the f₀ restoration circuit 202. Alternatively, the bandpass filter's bandpass may be fixed to a static passband of intonation frequencies.

An amplitude measurement circuit 204 determines the amplitude of the raw voice signal 220, which is used to adjust the amplitude of the isolated f₀ signal 126.

In an alternate embodiment, intonation processor 106 may synthesize the isolated f₀ signal 126 at the same frequency as the intonation frequency produced by the f₀ frequency measurement circuit 208.

In an alternate embodiment, f₀ restoration circuit 202 is omitted, and the raw voice signal 220 is fed directly into the bandpass filter 206 and f₀ frequency measurement circuit 208.

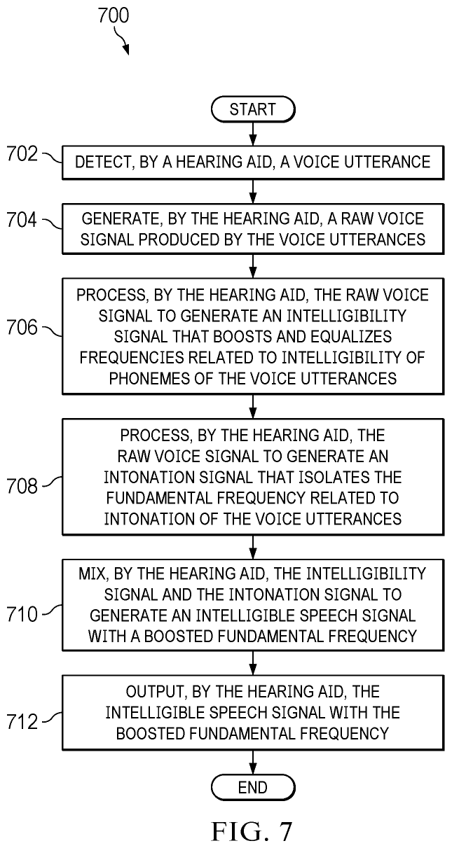

FIG. 7 depicts a flow chart illustrating a process for assisting recognition of intonation of speech in accordance with an illustrative embodiment. Process 700 may be implemented using hearing aid device 100, 200, shown in FIG. 1.

Process 700 begins by the hearing aid detecting a voice utterance (step 702) and generating a raw voice signal produced by the voice utterance (step 704).

An intelligibility processor in the hearing aid processes the raw voice signal to generate an intelligibility signal that boosts and equalizes frequencies related to intelligibility of phonemes of the voice utterance (step 706). The intelligibility processor may perform amplitude compression to generate the intelligibility signal.

An intonation processor in the hearing aid processes the raw voice signal to generate an intonation signal that isolates the fundamental frequency related to intonation of the voice utterance (step 708). The intonation processor may perform heterodyne mixing to ensure that signals at the fundamental frequency are at high relative amplitude to their harmonics within vocal formants of the voice utterance. The intonation processor may adjust the amplitude of the intonation signal according to the amplitude of the raw voice signal. The intonation processor may comprise a bandpass filter that isolates the fundamental frequency from the raw voice signal. The passband of the bandpass filter may be centered according to a scalar value of the fundamental frequency measured by the intonation processor.

A mixer mixes the intelligibility signal and the intonation signal to generate an intelligible speech signal with a boosted fundamental frequency (step 710), which is emitted by an output transducer (step 712). Process 700 then ends.

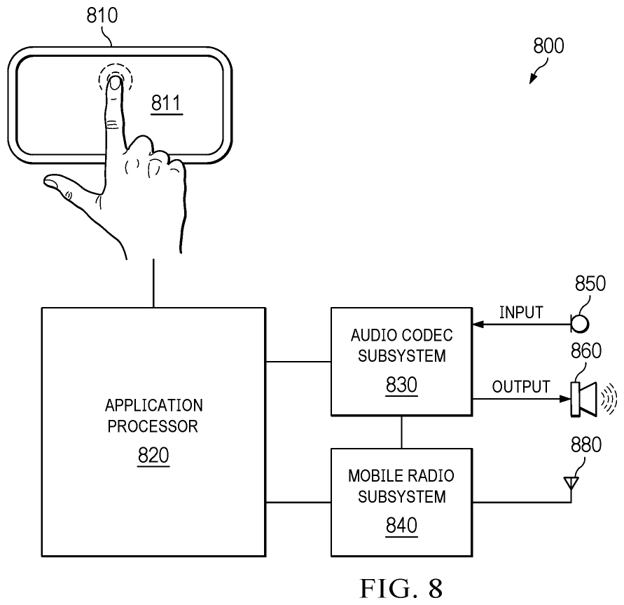

FIG. 8 depicts a block diagram illustrating a schematic diagram of hearing aid device incorporated into a mobile device in accordance with an illustrative embodiment. System 800 includes an application processor 820 that is operably connected to and/or communicates with an audio codec subsystem 830 and a mobile radio subsystem 840. A computing device 810 such as, e.g., a mobile phone, can provide a touch screen user interface 811 that allows the user to select the hearing aid application software. Such an application can be executed in application processor 820, which may comprise a digital signal processor from Texas Instruments®, Cirrus Logic®, Inc., or other manufacturer.

The application processor 820 can couple to the mobile radio subsystem 840, which can receive and transmit voice and data signals for a cellular phone (e.g., such as a smartphone) or another computing device, such as, for example, a tablet computing device. The mobile radio subsystem 840 couples to an antenna 870 for receiving and transmitting voice and data signals that in some example embodiments can be incorporated into the cellular phone/tablet body and not as a separate antenna. Application processor 820 and mobile radio subsystem 840 couple to audio codec subsystem 830. Microphone 850 receives voice sound that is input to audio codec 830. Speaker 860 receives amplified and filtered output sound from audio codec subsystem 830. In accordance with some embodiments of this disclosure, audio codec subsystem 830 can comprise circuitry to implement a digital low pass filter and amplifier. In accordance with other example embodiments, the audio codec subsystem 830 can be implemented as a secondary DSP that includes functionality to emphasize the fundamental frequency while attenuating distracting harmonics.

Exemplary embodiments of the application processor 820, mobile radio subsystem 840, and audio codec subsystem 830 for implementation of the hearing aid device are shown and described in, for example, “Unleashing the Audio Potential of Smartphones: Dedicated Audio ICs Like Smart Audio Codecs and Hybrid Class-D Amplifiers Can Help Solve System Level Challenges” by Rob Kratsas, Cirrus Logic, Inc., Austin, Texas, which is incorporated herein by reference in its entirety.

The hearing aid device described herein with respect to various example embodiments can assist wearers to discern the fundamental frequency h, and hence intonation, when they are listening to people speak. Filtering present in the hearing aid device allows removal of distractions present in the pitch itself, limiting the overtones that are produced, and reducing the sound to its formant, or fundamental pitch frequency.

It should be appreciated that some aspects of the disclosed embodiments can be carried out by software including computer program code. In some example embodiments, computer program code for carrying out operations of the disclosed embodiments may be written in an object oriented programming language (e.g., Java, C#, C++, etc.). Such computer program code, however, for carrying out operations of particular embodiments can also be written in conventional procedural programming languages, such as the “C” programming language or in a visually oriented programming environment, such as, for example, Visual Basic.

The program code may execute entirely on the user's computer, partly on the user's computer, as a stand-alone software package, partly on the user's computer and partly on a remote computer, or entirely on the remote computer. In the latter scenario, the remote computer may be connected to a user's computer through a local area network (LAN) or a wide area network (WAN), wireless data network e.g., Wi-Fi, Wimax, IEEE 802.xx, and cellular network, or the connection may be made to an external computer via most third party supported networks (e.g., through the Internet via an Internet Service Provider).

The embodiments are described at least in part herein with reference to flowchart illustrations and/or block diagrams of methods, systems, and computer program products and data structures according to embodiments of the invention. FIG. 5, for example, depicts a detailed flow chart of operations with blocks containing examples of instructions or steps. It will be understood that each block of the illustrations, and combinations of blocks, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the various block or blocks, flowcharts, and other architecture illustrated and described herein.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

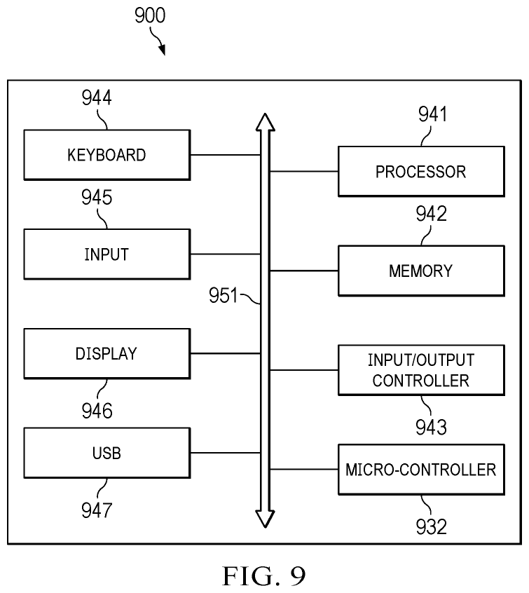

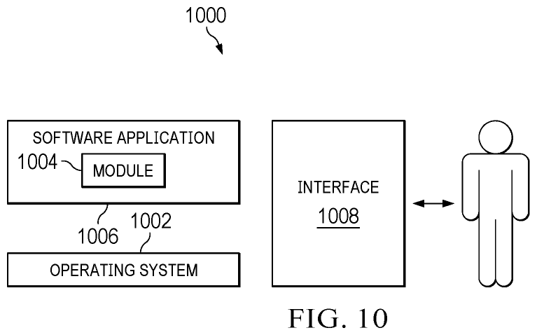

FIGS. 9 and 10 are provided as exemplary diagrams of data-processing environments in which embodiments may be implemented. It should be appreciated that FIGS. 9 and 10 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 9, some embodiments may be implemented in the context of a data-processing system 900 that can include one or more processors such as a processor 941, a memory 942, a controller 943 (e.g., an input/output controller), a peripheral USB (Universal Serial Bus) connection 947, a keyboard 944 or other input device (e.g., a physical keyboard or a touch screen graphically displayed keyboard), an input component 945 (e.g., a pointing device, such as a mouse, track ball, pen device, which may be utilized in association or with the keyboard 944, etc.), a display 946, and in some cases, a micro-controller 932.

Data-processing system 900 may be, for example, a client computing device (e.g., a client PC, laptop, mobile telephone, tablet computing device, a wearable computing device, etc.), which communicates with peripheral devices (not shown) via a client-server network (e.g., wireless and/or wired). In still other example embodiments, the data-processing system 900 can be implemented as a server in the context of a client-server network or other server-based network implementation.

In some example embodiments, the processor 941 may function, for example, as the application processor 820 shown in FIG. 8, and the display 846 may graphically display, for example, the touch screen user interface 811 of the computing device 810 shown in FIG. 8. The data-processing system 900 can implement the computing device 810 shown in FIG. 8. In some example embodiments, the data-processing system 900 may be implemented as or in the context of a wearable computing device—a miniature electronic device that can be worn by a user. Examples of wearable computing devices include, but are not limited to, so-called smartwatches, optical head-mounted displays (e.g., Google Glass, augmented reality devices, etc.).

As illustrated, the various components of data-processing system 900 can communicate electronically through a system bus 951 or other similar architecture. The system bus 951 may be, for example, a subsystem that transfers data between, for example, computer components within data-processing system 900 or to and from other data-processing devices, components, computers, etc. Data-processing system 900 may be implemented as, for example, a server in a client-server based network (e.g., the Internet) or can be implemented in the context of a client and a server (i.e., where aspects are practiced on the client and the server). Data-processing system 900 may be implemented in some embodiments, for example, as a standalone desktop computer, a laptop computer, a Smartphone, a pad computing device, a server, and so on.

FIG. 10 illustrates a computer software system 1000 for directing the operation of the data-processing system 900 shown in FIG. 9, in accordance with an illustrative embodiment. Software application 1006, stored for example in memory 942, generally includes a kernel or operating system 1002 and a shell or interface 1008. One or more application programs, such as software application 1006, may be “loaded” (i.e., transferred from, for example, memory 942 or another memory location) for execution by the data-processing system 900. The data-processing system 900 can receive user commands and data through the interface 1008. These inputs may then be acted upon by the data-processing system 900 in accordance with instructions from operating system 1002 and/or software application 1006. The interface 1008, in some embodiments, can serve to display results, whereupon a user may supply additional inputs or terminate a session.

The software application 1006 can include one or more modules such as, for example, a module 1004 (or a module composed of a group of modules), which can, for example, implement instructions or operations such as those described herein. Examples of instructions that can be implemented by module 1004 include steps or operations such as those shown and described herein with respect to the various blocks and operations described above. Module 1004 can include sub-modules such as, for example, the various blocks or modules shown in FIG. 8.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” such as module 1004 shown in FIG. 10 comprises a software application. However, a module may also be composed of, for example, electronic and/or computer hardware or such hardware in combination with software. In some cases, a “module” can also constitute a database and/or electronic hardware and software that interact with such a database.

Generally, program modules include, but are not limited to, routines, subroutines, software applications, programs, objects, components, data structures, etc., that perform particular tasks or implement particular data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein can refer to a collection of routines and data structures that perform a particular task or implement a particular data type. Modules may be composed of two parts: an interface, which lists the constants, data types, variable, and routines that can be accessed by other modules or routines; and an implementation, which is typically private (accessible only to that module) and which includes source code that actually implements the routines in the module. The term module may also simply refer to an application, such as a computer program designed to assist in the performance of a specific task, such as word processing, accounting, inventory management, etc. Thus, the instructions or steps such as those described herein can be implemented in the context of such a module or modules, sub-modules, and so on.

FIGS. 9 and 10 are thus intended as examples and not as architectural limitations of disclosed embodiments. Additionally, such embodiments are not limited to any particular application or computing or data processing environment. Instead, those skilled in the art will appreciate that the disclosed approach may be advantageously applied to a variety of systems and application software. Moreover, the disclosed embodiments can be embodied on a variety of different computing platforms, including, for example, Windows, Macintosh, UNIX, LINUX, and the like.

The flowchart and block diagrams in the different depicted embodiments illustrate the architecture, functionality, and operation of some possible implementations of apparatus and methods in an illustrative embodiment. In this regard, each block in the flowcharts or block diagrams may represent a module, a segment, a function, and/or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram.

The term “couple” or “couples” is intended to mean either an indirect or direct connection. Thus, if a first device couples to a second device, that connection can be through a direct connection, or through an indirect connection via other devices and connections.

As used herein, the phrase “a number” means one or more. The phrase “at least one of”, when used with a list of items, means different combinations of one or more of the listed items may be used, and only one of each item in the list may be needed. As used herein, the phrase “at least one of”, when used with a list of items, means different combinations of one or more of the listed items may be used, and only one of each item in the list may be needed. In other words, “at least one of” means any combination of items and number of items may be used from the list, but not all of the items in the list are required. The item may be a particular object, thing, or a category.

For example, without limitation, “at least one of item A, item B, or item C” may include item A, item A and item B, or item B. This example also may include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

The description of the different illustrative embodiments has been presented for purposes of illustration and description and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the invention.

What is claimed is:

1. A method for assisting recognition of intonation of speech, the method comprising:
detecting, by a hearing aid, a voice utterance;
generating, by the hearing aid, a raw voice signal produced by the voice utterance;
processing, by the hearing aid, the raw voice signal to generate an intelligibility signal that boosts and equalizes frequencies related to intelligibility of phonemes of the voice utterances;
processing, by the hearing aid, the raw voice signal to generate an intonation signal that isolates the fundamental frequency related to intonation of the voice utterance;
mixing, by the hearing aid, the intelligibility signal and the intonation signal to generate an intelligible speech signal with a boosted fundamental frequency; and
outputting, by the hearing aid, the intelligible speech signal with the boosted fundamental frequency.

2. The method of claim 1, wherein processing the raw voice signal to generate the intelligibility signal comprises amplitude compression.

3. The method of claim 1, wherein processing the raw voice signal to generate an intonation signal comprises heterodyne mixing to ensure that signals at the fundamental frequency are at high relative amplitude to their harmonics within vocal formants of the voice utterances.

4. The method of claim 1, wherein processing the raw voice signal to generate an intonation signal comprises determining a scalar value of the fundamental frequency.

5. The method of claim 1, wherein processing the raw voice signal to generate an intonation signal comprises adjusting the amplitude of the intonation signal according to the amplitude of the raw voice signal.

6. The method of claim 1, wherein processing the raw voice signal to generate an intonation signal comprises isolating the fundamental frequency from the raw voice signal with a bandpass filter.

7. The method of claim 6, further comprising centering the passband of the bandpass filter according to a scalar value of the fundamental frequency.

8. A hearing aid system for assisting recognition of intonation of speech, the hearing aid system comprising:
a storage device configured to store program instructions; and
one or more processors operably connected to the storage device and configured to execute the program instructions to cause the hearing aid system to:
detect a voice utterance;
generate a raw voice signal produced by the voice utterance;
process the raw voice signal to generate an intelligibility signal that boosts and equalizes frequencies related to intelligibility of phonemes of the voice utterances;
process the raw voice signal to generate an intonation signal that isolates the fundamental frequency related to intonation of the voice utterance;
mix the intelligibility signal and the intonation signal to generate an intelligible speech signal with a boosted fundamental frequency; and
output the intelligible speech signal with the boosted fundamental frequency.

9. The hearing aid system of claim 8, wherein processing the raw voice signal to generate the intelligibility signal comprises amplitude compression.

10. The hearing aid system of claim 8, wherein processing the raw voice signal to generate an intonation signal comprises heterodyne mixing to ensure that signals at the fundamental frequency are at high relative amplitude to their harmonics within vocal formants of the voice utterance.

11. The hearing aid system of claim 8, wherein processing the raw voice signal to generate an intonation signal comprises determining a scalar value of the fundamental frequency.

12. The hearing aid system of claim 8, wherein processing the raw voice signal to generate an intonation signal comprises adjusting the amplitude of the intonation signal according to the amplitude of the raw voice signal.

13. The hearing aid system of claim 8, wherein processing the raw voice signal to generate an intonation signal comprises isolating the fundamental frequency from the raw voice signal with a bandpass filter.

14. A hearing aid device, comprising:
an input transducer that generates a raw voice signal in response to detecting a voice utterance;
an intelligibility processor that processes the raw voice signal to generate an intelligibility signal that boosts and equalizes frequencies related to intelligibility of phonemes of the voice utterance;
an intonation processor that processes the raw voice signal to generate an intonation signal that isolates the fundamental frequency related to intonation of the voice utterance;
a mixer that mixes the intelligibility signal and the intonation signal to generate an intelligible speech signal with a boosted fundamental frequency; and
an output transducer that emits the intelligible speech signal with the boosted fundamental frequency.

15. The hearing aid device of claim 14, wherein the intelligibility processor performs amplitude compression.

16. The hearing aid device of claim 14, wherein the intonation processor performs heterodyne mixing to ensure that signals at the fundamental frequency are at high relative amplitude to their harmonics within vocal formants of the voice utterance.

17. The hearing aid device of claim 14, wherein the intonation processor determines a scalar value of the fundamental frequency.

18. The hearing aid device of claim 14, wherein the intonation processor adjusts the amplitude of the intonation signal according to the amplitude of the raw voice signal.

19. The hearing aid device of claim 14, wherein the intonation processor comprises a bandpass filter that isolates the fundamental frequency from the raw voice signal.

20. The hearing aid device of claim 14, wherein the passband of the bandpass filter is centered according to a scalar value of the fundamental frequency.
